(19) United States
(12) Patent Application Publication
(10) Pub. No.: US 2009/0307061 A1
(43) Pub. Date: Dec. 10, 2009

(54) Measuring Exposure To Media

(75) Inventors: Brian Monighetti, San Ramon, CA (US); Tamara Gaffney, Belmont, CA (US); Mark D. Klein, Los Altos, CA (US)

Correspondence Address: RAUBVOGEL LAW OFFICE, 820 LAKEVIEW WAY, REDWOOD CITY, CA, 94062, US

(73) Assignee: INTEGRATED MEDIA MEASUREMENT, INC., San Mateo, CA (US)

(21) Appl. No.: 12/481,369

(22) Filed: Jun. 9, 2009

Related U.S. Application Data
(63) Continuation-in-part of application No. 12/478,502, filed on Jun. 4, 2009.
(60) Provisional application No. 61/060,329, filed on Jun. 10, 2008.

(51) Int. Cl. G06Q 10/00; G06Q 50/00

(52) U.S. Cl. 705/10

(57) ABSTRACT

Exposure to media content across one or more media delivery mechanisms is measured. The delivery mechanisms can include, for example, television and radio, as well as Internet delivery of web pages or other content viewed on a computer, mobile device, or other electronic device using a browser or other application. Media can include web-based content and/or audio content originating from a network source and/or from other content sources. Reference signatures are generated for media content items of interest. Monitoring devices and/or software monitor user exposure to media items, and intercepted signatures are generated. In some embodiments, user exposure across multiple delivery mechanisms is monitored. Reports can be generated based on comparison of the intercepted signatures with the reference signatures; such reports may include analysis of media exposure across multiple delivery mechanisms. Content items can be selected for presentation to a user based on media exposure history.

### CROSS-REFERENCE TO RELATED APPLICATIONS

The present application claims priority from U.S. Provisional Patent Application No. 61/060,329, filed on Jun. 10, 2008 and entitled “Measuring Exposure to Media Across Multiple Media Delivery Mechanisms,” (Atty. Docket No. IMM003-PROV), the disclosure of which is incorporated herein by reference.

The present application further claims priority as a continuation-in-part of U.S. Utility patent application Ser. No. 12/478,502, filed on Jun. 4, 2009 and entitled “Measuring Exposure to Media Across Multiple Media Delivery Mechanisms,” (Atty. Docket No. IMM004), the disclosure of which is incorporated herein by reference.

The invention described herein is related to the following U.S. patent applications, the disclosures of which are incorporated herein by reference:
U.S. patent application Ser. No. 11/216,543, filed Aug. 30, 2005, for “Detecting and Measuring Exposure to Media Content Items” (Atty. Docket No. IMM10389);
U.S. patent application Ser. No. 11/359,903, filed Feb. 21, 2006, for “Personal Music Preference Determination Based on Listening Behavior” (Atty. Docket No. IMM11312); and
U.S. patent application Ser. No. 12/105,440, filed Apr. 18, 2008, for “Personalized Media Delivery Based on Detected Media Exposure” (Atty. Docket No. IMM002).

### BACKGROUND OF THE INVENTION

1. Field of the Invention

The invention generally relates to techniques for measuring exposure to media items.

2. Description of Background Art

In order to gauge the impact of advertising, the reach of media content, and the size of an audience, it is often useful to determine the number of people who are exposed to media items. For authors, owners, distributors, and/or producers of content, such measurement is useful to determine the popularity, appeal, and success of a media item. For advertisers, audience measurement is useful to determine return on investment for an advertisement, and thereby to help inform decisions as to which marketing channels are most effective.

Media exposure is typically measured in different ways for different types of media. Such measurements are usually separate and independent of one another, without any meaningful correlation or association between measurements of audience sizes for different media types. For each delivery mechanism, such as television, radio, Internet, or the like, measurement of media exposure is conventionally performed in a different manner and using different measurement techniques.

Furthermore, in many cases a different set of panelists is enlisted for each delivery mechanism, because it would be overly burdensome for a particular panelist to be subjected to multiple forms of media consumption monitoring so as to measure that panelist's exposure across various delivery mechanisms. In addition to being burdensome, such an attempt to measure media exposure across multiple delivery mechanisms would compromise the accuracy of the measurements, since accurate measurement generally requires that the monitoring techniques be non-intrusive into panelists' daily lives.

Consequently, it is difficult, using conventional measurement techniques, to gain insight into media exposure across multiple delivery mechanisms. Employing different sets of panelists for each delivery mechanism makes it difficult or impossible to report on overall audience size and overlap of use across media platforms. Existing techniques therefore often fail to provide an overview of aggregate exposure to various media items and types of media items. Accordingly, it is often difficult for stakeholders to determine overall audience size and media exposure, when such exposure might have taken place over multiple delivery mechanisms.

Furthermore, conventional techniques for measuring exposure to content items often fail to recognize related content when presented from different sources, even within a particular delivery mechanism. For example, exposure to content delivered over the Internet, such as web pages, is usually measured in terms of specific uniform resource locators (URLs) of web pages viewed by each panelist. In cases where similar or related content is delivered via different URLs, conventional techniques often fail to recognize or report on the aggregate media exposure across all sources including, for example, distinct URLs and/or Internet sources.

### SUMMARY OF THE INVENTION

In various embodiments, the present invention is a system and method for measuring media exposure for a set of panelists by monitoring one or more media delivery mechanisms (also referred to as “platforms”). The delivery mechanisms can include, for example, television and radio, as well as Internet delivery of web pages or other content viewed on a computer, mobile device, or other electronic device using a browser or other application. The present invention can be implemented in connection with any combination of delivery mechanisms. Media can include web-based content and/or audio content originating from a network source and/or from other content sources such as local sources.

For example, an audio intercept device carried by a panelist can monitor ambient audio and thereby detect audio content items to which the panelist is exposed. As another example, an Internet content monitoring device can be implemented as software installed on an electronic device capable of receiving and presenting Internet content (such as a computer, mobile device, smartphone, or the like); the software monitors HTML, digital audio, and/or other content delivered to the electronic device. As another example, software installed on a computing device can monitor audio content being output at the computing device, such as audio content originating from a local source. In one embodiment, the present invention is implemented as a system including a plurality of components for monitoring media exposure across different delivery mechanisms, so as to generate reports of aggregate exposure over multiple delivery mechanisms.

Content items detected by the various monitoring devices are converted to signatures. These signatures can be representations of audio content, web (HTML) content, and/or any other type of content. The signatures can be comprehensive representations of the content items, or they can represent selected attributes or characteristics of particular interest. In one embodiment, signatures representing web content can represent such content independently of the URL (or other location identifier) from which the content was received.

Reference signatures are obtained by any of a number of techniques. For example, reference signatures can be obtained by monitoring media content streams in relevant markets, by analyzing web pages extracted by crawling the web or provided by a website operator, and/or by processing content items that can be made available in other ways.

Signatures generated from monitored media exposure are compared with reference signatures to identify matches. In one embodiment, different signature comparison mechanisms can be used for different types of content; for example, one signature comparison mechanism can be provided for comparing signatures representing audio content, while another can be provided for comparing signatures representing HTML content. In another embodiment, signatures generated from exposure to web-based content are compared against reference signatures to identify matches. In yet another embodiment, signatures generated from exposure to audio content, delivered via a computing device and originating from any of a number of sources, including local optical and/or magnetic storage as well as network-based sources, are compared against reference signatures to identify matches.

Based on the identified matches, media content exposure reports can be generated that include analysis of media exposure, including, if desired, media exposure to audio content delivered on a computing device and/or media exposure across multiple delivery mechanisms. An advertiser, producer, author, or other stakeholder can thus be provided with an integrated report that helps gain insight into patterns of media exposure, advertisement effectiveness, and user behavior without being limited to a single delivery mechanism. In some embodiments, the identified matches can be used for selecting content items, such as advertisements or other programming, to be presented to a user and/or to other users having similar demographic characteristics or other relevant characteristics. Thus, certain content items can be identified as likely to be of interest to a user, and presented to the user based on their media exposure history and/or based on media exposure history of similar users.

Accordingly, the system and method of the present invention facilitate measurement of cross-platform media exposure (such as content on television, radio, websites, telephones, and the like) to determine how people consume content across different delivery mechanisms, and to establish relationships among such forms of content consumption.

For example, a panelist may watch a hockey game on television and then look up statistics on ESPN or view a video clip on ESPN. The system and method of the present invention can identify panelists who visited the ESPN website to look up statistics or to view a game highlight after watching the hockey game on television. Likewise, the system and method of the present invention can measure the effectiveness of commercials advertising cross-platform media availability. For example, if a set of panelists view a commercial related to a website, the invention can measure the percentage of panelists who subsequently go to that website. The invention can also be used to report on consumption of media (including advertisements) appearing on TV, on the radio, in the movie theater, in a video game, and/or on a website that is viewed on a PC, mobile device, and the like. In general, the invention can link causally the consumption of content over one delivery mechanism that is related to content previously consumed on that delivery mechanism or on another delivery mechanism.

The present invention provides additional advantages over conventional systems. For example, in one embodiment, signatures themselves can be examined for attributes of interest. Reports can be generated based on the extracted information, without necessarily comparing such signatures against reference signatures.

In various embodiments, signatures can be combined with behavioral information, location information, panelist purchasing information, and the like.

### BRIEF DESCRIPTION OF THE DRAWINGS

FIG. 1 is a block diagram depicting an architecture of the present invention for measuring exposure to media across multiple delivery mechanisms, according to one embodiment.

FIG. 2 is a flow diagram depicting a method of measuring exposure to media across multiple delivery mechanisms according to one embodiment.

FIG. 3 is a block diagram depicting an architecture of the present invention for measuring exposure to Internet-based media based on signatures for web content and/or exposure to audio content via a computing device, according to one embodiment.

FIG. 4 is a flow diagram depicting a method of measuring exposure to Internet-based media based on signatures for web content, according to one embodiment.

FIG. 5 is an example of a conversion report generated according to one embodiment of the present invention.

FIG. 6 is an example of a purchase report generated according to one embodiment of the present invention.

FIG. 7 is an example of a report showing relationships between website visitation patterns and audio exposure, generated according to one embodiment of the present invention.

One skilled in the art will recognize that the particular layouts and arrangements shown in the Figures are merely exemplary, and that the invention can be implemented in many other ways without departing from the essential characteristics as set forth in the claims.

### DETAILED DESCRIPTION OF THE EMBODIMENTS

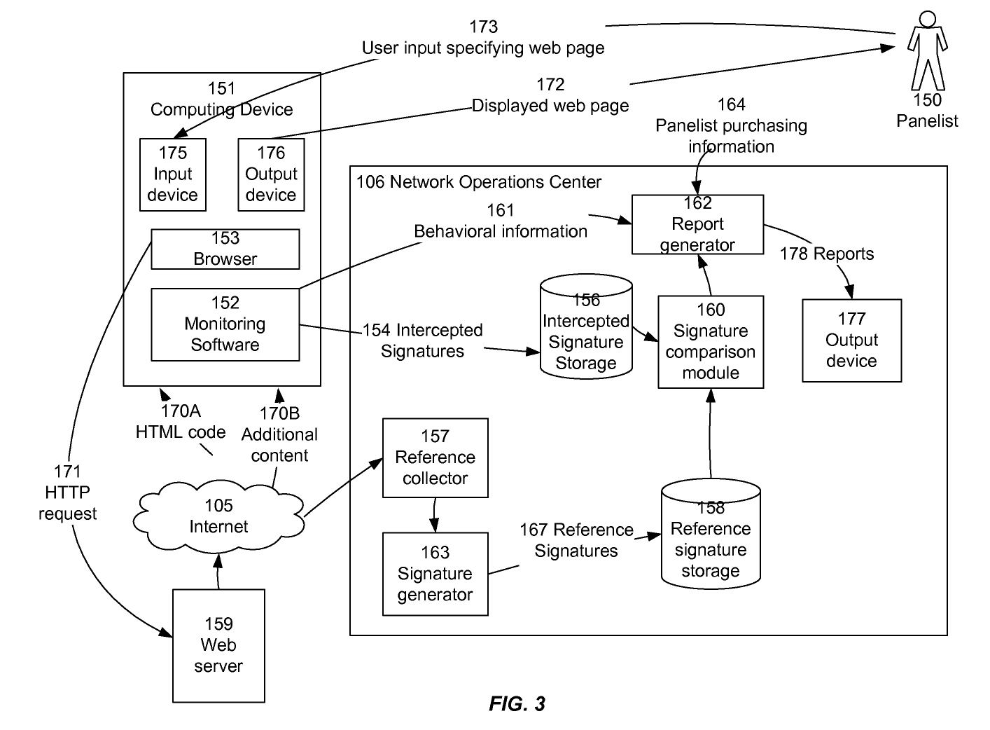

Referring now to FIG. 3, there is shown a block diagram depicting an architecture of the present invention for measuring exposure to Internet-based media based on signatures for web content and/or exposure to audio content via a computing device, according to one embodiment.

Computing device 151 is any electronic device capable of accessing content over a network such as the Internet 105, according to well-known protocols such as Transmission Control Protocol/Internet Protocol (TCP/IP) and/or Hypertext Transfer Protocol (HTTP). Computing device 151 can be a computer including a processor and memory, and may be adapted to run an operating system such as Microsoft Windows Vista, available from Microsoft Corporation of Redmond, Wash. Computing device can include input device 175, such as a keyboard, mouse, trackpad, touchpad, or the like. Computing device can include one or more output devices 176, which may be a display screen or the like and/or which may include a speaker, headphone jack, or other device for outputting audio content.

Computing device 151 can be a desktop computer, laptop computer, handheld computer, kiosk, netbook, personal digital assistant, cell phone, smartphone or the like. As is well known in the art, computing device 151 can run software adapted to perform various tasks and operations, including for example browser 153 adapted to retrieve web-based content from servers 159 and display such content on output device 176 in the form of web pages for a user such as panelist 150. One example of a browser 153 for displaying web-based content is Microsoft Internet Explorer, available from Microsoft Corporation of Redmond, Wash. In one embodiment, computing device 151 operates as a client for receiving content from web server 159 and other sources. For illustrative purposes, the source of web content is described herein as web server 159; however, this term is intended to refer to any possible source of content that is accessible over a network such as the Internet 105.

In one embodiment, output device 176 can output web-based audio content, and/or audio content 170C derived from any other content source such as local content source 179. In one embodiment, local content source 179 can be a CD, DVD, Blu-Ray disc, magnetic or optical storage, or the like, or any combination thereof. However, content source 179 is not essential to the present invention, and the invention can be practiced in an embodiment wherein this element is omitted.

Panelist 150 is any user. In one embodiment, panelist 150 is a user whose exposure to media is being tracked. In one embodiment, particular users are selected to be panelists, either by random selection, volunteering, paid participation, or the like. In the description provided herein, the term “panelist” is used interchangeably with the term “user”.

Panelist 150 interacts with browser 153 on computing device 151, for example to specify web pages to be viewed via browser 153. As is well known in the art, panelist 150 can request a web page by providing user input 173 via an input device 175 associated with computing device 151. Panelist 150 can, for example, type a Uniform Resource Locator (URL) in a location input field, click a link on a displayed web page or document, or activate a bookmark, “favorites” icon, or menu selection to specify a web page to be retrieved. Based on the user input 173, browser 153 causes computing device 151 to issue an HTTP request 171 to web server 159, specifying the location of to the requested content. In one embodiment, request 171 travels over the Internet 105. Web server 159 responds by providing HTML code 170A and/or additional content 170B, which may also travel over the Internet 105, to computing device 151. Additional content 170B may include, for example, packets of audio and/or the audio component of a video stream. Browser 153 interprets the received HTML code 170A and presents web page 172 on display screen or other output device 176 for panelist 150. In one embodiment, browser 153 or a plug-in can also interpret any received additional content 170B (if any) for display of audio and/or audiovisual content on output device 176.

In one embodiment, monitoring software 152 installed on computing device 151 monitors the content, or a subset of the content, of web pages viewed on browser 153. For example, monitoring software 152 may parse HTML code 170A as it is received at computing device 151, so as to extract words, phrases, and/or sentences from the HTML code 170A. Dynamic elements, such as Flash movies, JavaScript, and the like can be excluded from the parsing operation, or they can be included if the data found within is potentially meaningful. Tags, image content, and other elements may also be parsed if meaningful data for signatures can be found therein.

The monitored content is converted to one or more signatures representing attributes of interest that appear within the content; for example, the signature(s) may represent attributes of a web page displayed on browser 153. Each signature, referred to herein as an intercepted signature 154, is generated from HTML code 170A and/or additional content 170B received from web server 159 via the Internet 105, and thereby represents some aspect(s) of panelist's 150 Internet browsing behavior. In one embodiment, monitoring software 152 excludes non-content elements such as HTML format tags, so as to focus on attributes that describe content.

In one embodiment, monitoring software 152 monitors audio content delivered via output device 176; the audio content can have any source and can be delivered by any output device, including for example a speaker, or headphones, or some other means. For example, monitoring software 152 may interface with audio circuitry, such as a sound card or other audio component of computing device 151, and thereby detect audio signals intended for output at output device 176. In this manner, the system of the present invention can monitor audio content 170C originating from any content source, including for example local content source 179, which can include media such as CDs, DVDs, BluRay discs, local storage, or the like. Monitored content is converted to signatures, referred to as intercepted signatures, representing attributes of audio content output at device 176. By monitoring and transforming audio content using software 152 running on computing device 151, the system of the present invention is able to detect audio content to which panelist 150 is exposed, even if the audio content would not reliably detectable by a device that monitors ambient audio. For example, if panelist 150 is using headphones to listen to audio content such as music on computing device 151, an ambient audio detection device might not be able to detect the audio content; however, software 152 can interface with a sound card or other audio component of computing device 151 and thereby detect the audio content.

In one embodiment, intercepted signature 154 is generated by monitoring software 152. In another embodiment, monitoring software 152 forwards monitored content to another component on computing device 151 or at another location such as network operations center 106, and intercepted signature 154 is generated from the content at that location.

For example, if a research company were interested in measuring exposure to commentary, scores, or images relating to a specific event such as the Olympics, an appropriate algorithm is selected to create an intercepted signature 154 that represents such a web page regardless of the URL in which is it found. In one embodiment, intercepted signature 154 provides a way to discern web content independently of the URL or location from which the content was retrieved, and regardless of the original format of the web content.

In one embodiment, a simple tokenizing content-specific signature algorithm is used. A set of words is stored, along with associated tokens. Wild cards can be specified, for example, using ‘?’ to match any single character including null and ‘*’ to match any string of any length including an empty string. Thus, an example of a set of tokens associated with words might be:

| Token | Word |
|---|---|
| 1 | Olympic? |
| 2 | Swim* |
| 3 | gymnastics |
| 4 | Baseball |
| 5 | USA |
| 6 | Canada |

Using the above set of tokens, a signature for a web page about Olympics gymnastics might look like this: 1,3,5,6.

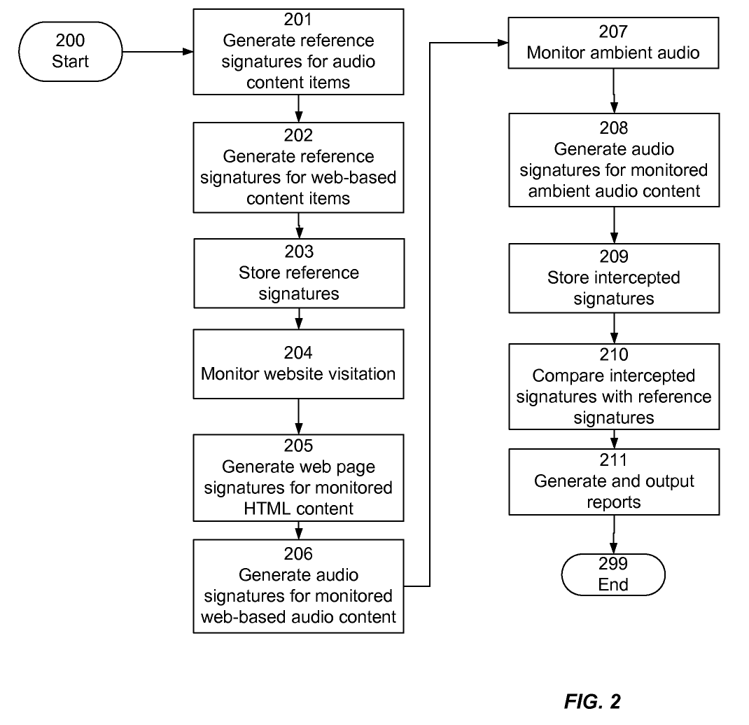

In one embodiment, intercepted signatures 154 for audio content are generated according to techniques described, for example, in related U.S. patent application Ser. No. 11/216,543, as described in more detail in connection with FIG. 2.

Network operations center 106 contains various components for storing, interpreting, and analyzing intercepted signatures 154, and for generating reports. In one embodiment, network operations center 106 is implemented at some central location, communicatively coupled with monitoring software 152 installed on various client computing devices 151. In one embodiment, network operations center 106 receives data (such as intercepted signatures 154) from computing devices 151 over the Internet 105, either directly or via intermediate data collectors, routers, and/or other components.

In one embodiment, network operations center 106 also includes components for collecting and storing reference signatures 167 against which intercepted signatures 154 can be compared. Reference signatures 167 can represent content that is of interest to a stakeholder, or they can represent general content on the web. Reference signatures 167 can be obtained by applying a signature algorithm to specific web pages and/or other web-based content provided to signature generator 163. Alternatively, a reference collector 157 can crawl the World Wide Web so as to collect web pages and/or other web-based content, forwarding these items to signature generator 163. The web-crawl can be open-ended, or it can be constrained to a set of pages of interest. In one embodiment, reference signatures 167 are stored at storage device 158, which may be located at network operations center 106 or at some other location. In one embodiment, signature generator 163 excludes non-content elements such as HTML format tags, so as to focus on attributes that describe content.

In one embodiment, intercepted signatures 154 are stored at storage device 156, which may be the same storage device 158 used for storing reference signatures 167 or may be a different storage device. In one embodiment, a compression method, such as Huffman coding, is used to compress signatures, including intercepted signatures 154 and/or reference signatures 167.

Signature comparison module 160 algorithmically compares intercepted signatures 154 for a panelist's 150 Internet browsing activity, stored at storage device 156, with reference signatures 167 stored at storage device 158. By detecting matches between intercepted signatures 154 and reference signatures 167, comparison module 160 can identify specific web pages visited by panelist 150, as well as particular content items viewed by panelist 150 regardless of the specific URL at which they were viewed.

For example, an Associated Press article may be picked up by many different news organizations, and may therefore appear on many different websites. A reference signature 167 for the article identifies the article in terms of its content independently of its particular URL or location on the web. By comparing intercepted signature 154 against reference signature 167 for the article, signature comparison module 160 is able to determine whether panelist 150 has viewed the article, regardless of the particular URL or location at which the article was viewed. In one embodiment, the URL or location identifier can also be provided as supplemental information if desired.

Reference signatures 167 can contain information describing an entire content item (such as a web page, article, or audio content item), or a portion thereof, or specific excerpts, key words, phrases, sentences, authors, topics, or other attributes. Thus, module 160 is able to identify and report on intercepted signatures 154 that relate to a particular content item or to any content item having specified attributes.

In another embodiment, signature comparison module 160 algorithmically compares intercepted signatures 154 for a panelist's 150 exposure to audio content (such as audio content 170C from local source 179, and/or audio content found in additional content 170B), stored at storage device 156, with reference signatures 167 stored at storage device 158. By detecting matches between intercepted signatures 154 and reference signatures 167, comparison module 160 can identify specific audio content items to which panelist 150 has been exposed.

In one embodiment, a match index, or score, is calculated based on the percentage of matches between intercepted signatures 154 and reference signatures 167, and the order of the matched signatures. In one embodiment, an intercepted signature 154 is considered a match if it exactly matches a reference signature 167.

In another embodiment, a semantic extraction technique such as categorical grammar analysis is used to obtain terms of interest from intercepted signatures 154. These terms can then be scored against terms extracted from reference signatures 167.

Based on the comparisons performed by signature comparison module 160, in one embodiment report generator 162 generates reports 178 summarizing website browsing activity and/or content to which panelist 150 has been exposed. Reports can be presented on any output device 177, such as a screen or printer, and/or can be stored or transmitted. Reports 178 can take any form as specified by a website operator, advertiser, or other stakeholder. For example, reports 178 can include advertising conversion reports indicating the degree to which panelists 150 exposed to advertisements tend to visit advertised web pages and/or purchase advertised products and services.

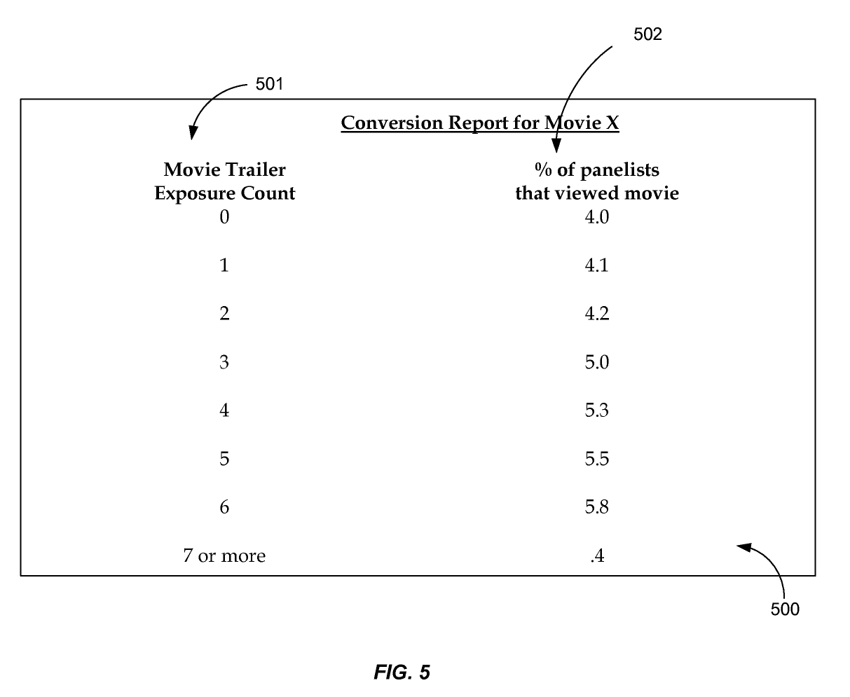

Referring now to FIG. 5, there is shown an example of a conversion report 500 generated by the system of the present invention. For each count of exposures to a movie trailer in column 501, column 502 indicates what percentage of panelists 150 viewed the movie associated with the trailer. Thus, report 500 provides an indication of the effect of exposures to the movie trailer on the likelihood a viewer will view the movie.

In some embodiments, the identified matches can be used for selecting content items, such as advertisements or other programming, to be presented to a user. For example, certain content items, from a set of candidate content items, can be identified as being related to media to which a panelist has been exposed. The identified content items can then be presented to the panelist at an appropriate time (such as at the next opportunity to present an advertisement to the panelist). In this manner, advertisements and/or other content items are identified as likely to be of interest to a user, and presented to the user based on their media exposure history. In various embodiments, such selection of content items can be performed in lieu of or in addition to generation of reports as to media exposure.

In another embodiment, the system of the present invention is adapted to detect panelist 150 exposure to particular websites of interest. URLs and/or signatures for websites of interest are sent to monitoring software 152 at computing device 151, and comparison is performed on computing device 151. Match events can be time-stamped and sent to network operations center 106 along with identification of panelist 150.

In addition to comparing intercepted signatures 154 with reference signatures 167, in one embodiment the system of the present invention is able to examine intercepted signatures 154 themselves for particular attributes of interest. Useful information regarding panelist's 150 interests and/or web visitation patterns can thus be obtained without necessarily comparing against reference signatures 167. For example, monitoring software 152 can extract particular words to form intercepted signatures 154 representing content viewed by panelist 150. These intercepted signatures 154 can be directly examined at network operations center 106 for the presence of words or attributes related to a subject of interest (for example, “gymnast”, “Olympics”, or the like). In this manner, network operations center 106 can measure panelist 150 exposure to content related to certain topics of interest, be they general or specific.

In another embodiment, the system of the present generates intercepted signatures 154 by performing a transformation, such as a hash transformation, on HTML code 170A for content retrieved from server 159. Signatures 154 generated by the transformation can be unique or non-unique. Dynamic content, such as JavaScript or other executable code, may or may not be included. Image content, in a digital format such as JPG or GIF, may or may not be included as well. In one embodiment, the URL can be included when performing the transformation to generate intercepted signature 154, for example as an aid in resolving ambiguity. Signature generator 163 at network operations center 106 performs similar transformations, such as hash transformations, on web-based content obtained from a web crawl of the Internet (either open-ended or constrained to a set of pages of interest), and/or on content separately provided to network operations center 106, so as to generate references signatures 167. Thus, in this embodiment, signatures 154 and 167 represent hash transformations (or other transformations) rather than extracted key words. Signature comparison module 160 performs an exact or close-match algorithm to identify matches between intercepted signatures 154 and reference signatures 167.

In one embodiment, a tokenizing hashing algorithm is used. Multiple words can be mapped to a single token.

Thus, for example, the following mappings can be used:

| Token | Word |
|---|---|
| 1 | a |
| 1 | an |
| 2 | the |
| 3 | and |
| 4 | red |
| 5 | car |
| 6 | see |
| 7 | i |

A case-insensitive hash of the sentence, “I see the red car” would result in the signature 7,6,2,4 5.

In one embodiment, a matching algorithm for finding close matches may ignore certain words or word types. For example, if adjectives are ignored, both “I see the red car” (7,6,2,4,5) and “I see the car” (7,6,2,5) would match when compared.

In one embodiment, intercepted signatures 154 are generated by performing a transformation, such as a hash transformation, on image files in a digital format (such as JPG or GIF). Similar transformations are performed on reference images collected by reference collector 157. Comparison of the signatures yields information as to what images have been viewed by panelist 150. Again, the URL can be included when performing the transformation, so as to reduce or resolve ambiguity in cases where multiple web pages or images carry similar or identical images.

In one embodiment, report generator 162 receives additional information that can provide beneficial insight into panelist 150 behavior, particularly when combined with website visitation data collected using the signature-based techniques described above. For example, in one embodiment, monitoring software 152 provides behavioral information 161, such as a list of web sites visited, and/or time and date of such visits, to network operations center 106. In one embodiment, network operations center 106 obtains information regarding purchases 164 made by panelist 150; such information may be obtained, for example, from external sources tracking credit card use, or from e-commerce sites or the like. The additional information such as behavioral information 161 and/or purchasing information 164 is used by report generator 162 to generate reports 178 that correlate specific behaviors (such as purchases) with content viewed by panelist 150 as determined by the signature comparison techniques described above.

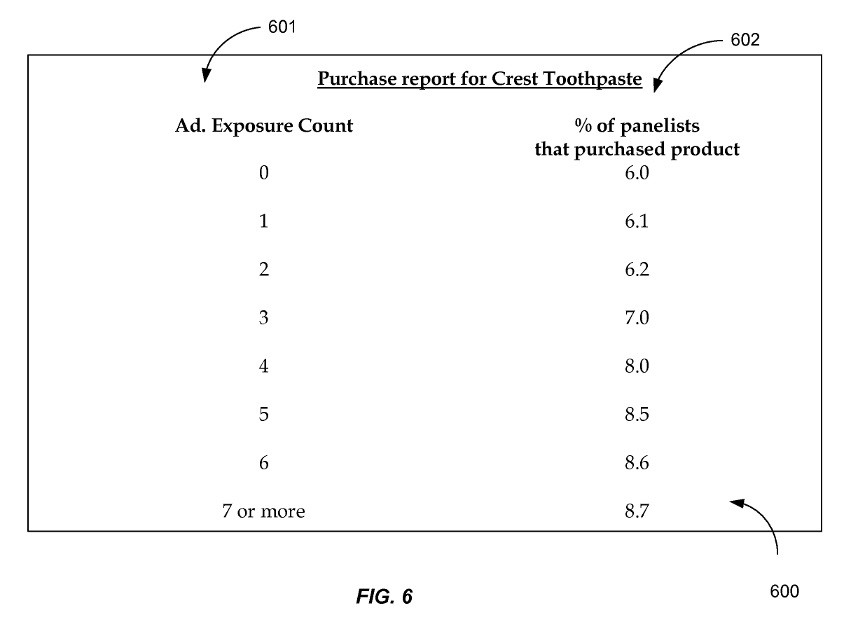

Referring now to FIG. 6, there is shown an example of a purchase report 600 generated by the system of the present invention. For each count of exposures to an advertisement in column 601, column 602 indicates what percentage of panelists 150 purchased the product associated with the advertisement. Thus, report 600 provides an indication of the effect of exposures to the advertisement on the likelihood a viewer will purchase the product.

One skilled in the art will recognize that any or all of the above-described techniques can be combined with one another in various ways to enhance the overall functionality of the system.

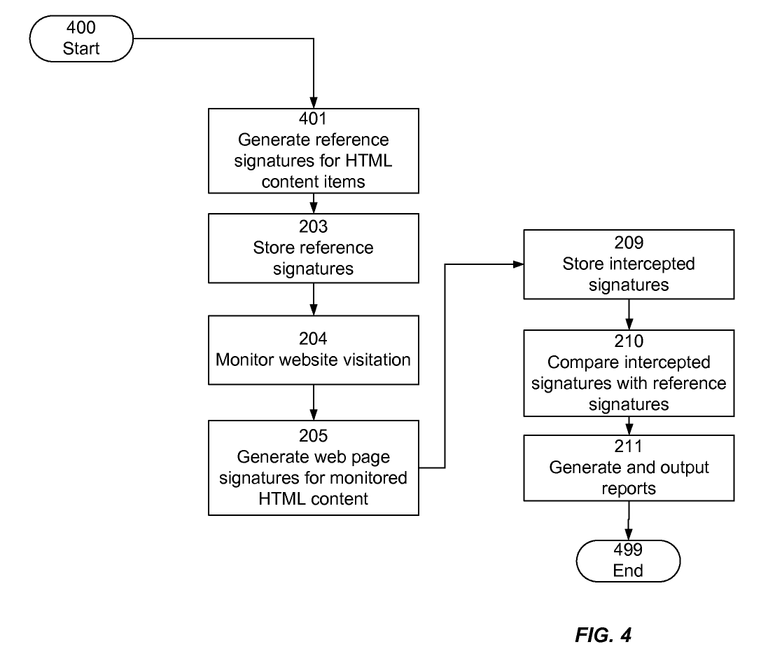

Referring now to FIG. 4, there is shown a flow diagram depicting a method of measuring exposure to Internet-based media based on signatures for web content, according to one embodiment. In one embodiment, the steps depicted in FIG. 4 are performed by a system such as that described above in connection with FIG. 3. Accordingly, reference numerals referring to components of FIG. 3 are included in the following description; however, one skilled in the art will recognize that the method of FIG. 4 can be performed by systems having different components and architecture than those shown in FIG. 3.

Signature generator 163 generates 401 reference signatures 167 for HTML content items and other web-based content collected by reference collector 157. As described above, these content items can include web-based content collected during a web crawl (ether comprehensive or constrained), and/or content items provided directly to signature generator 163. Reference signatures 167 are stored 203 in reference signature storage 158.

Monitoring software 152 monitors 204 website visitation of panelist 150, based on web pages and other web content viewed via browser 153, and generates 205 signatures 154, referred to herein as intercepted signatures 154. Intercepted signatures 154 are transmitted to network operations center 106, where they are stored 209 in intercepted signature storage 156.

One skilled in the art will recognize that the above-described steps can be performed sequentially or in parallel. For example, website visitation monitoring 204 can take place while reference signatures 167 are still being generated 401 and/or stored 203.

Signature comparison module 160 compares 210 intercepted signatures 154 with reference signatures 167. Based on the comparison, in one embodiment report generator 162 generates 211 and outputs reports 178 on output device 177. In other embodiments, based on the comparison, certain content items are identified for presentation to the user. In yet other embodiments, based on the comparison, certain content items are identified for presentation to other users having similar demographic characteristics, and/or other relevant characteristics, as the user.

In one embodiment, the above-described techniques are integrated with techniques for comparing signatures for content delivered by mechanisms other than the Internet 105, and/or for content other than websites. For example, the above-described techniques can be combined with mechanisms for detecting panelist 150 exposure to audio media, thus enabling generation of reports that correlate website visitation patterns with exposure to various types of content items delivered in various ways.

In order to detect and identify panelist 150 exposure to audio media, in one embodiment the system of the present invention uses a device carried by panelist 150 and containing a microphone to detect ambient audio. The detected audio is converted to signatures that are compared against reference obtained from television, radio, movie trailer, and other reference media containing audio. Techniques for such audio signature comparison are described, for example, in related U.S. patent application Ser. No. 11/216,543 (Atty. Docket No. IMM10389), filed on Aug. 30, 2005, for “Detecting and Measuring Exposure to Media Content Items”, the disclosure of which is incorporated herein by reference.

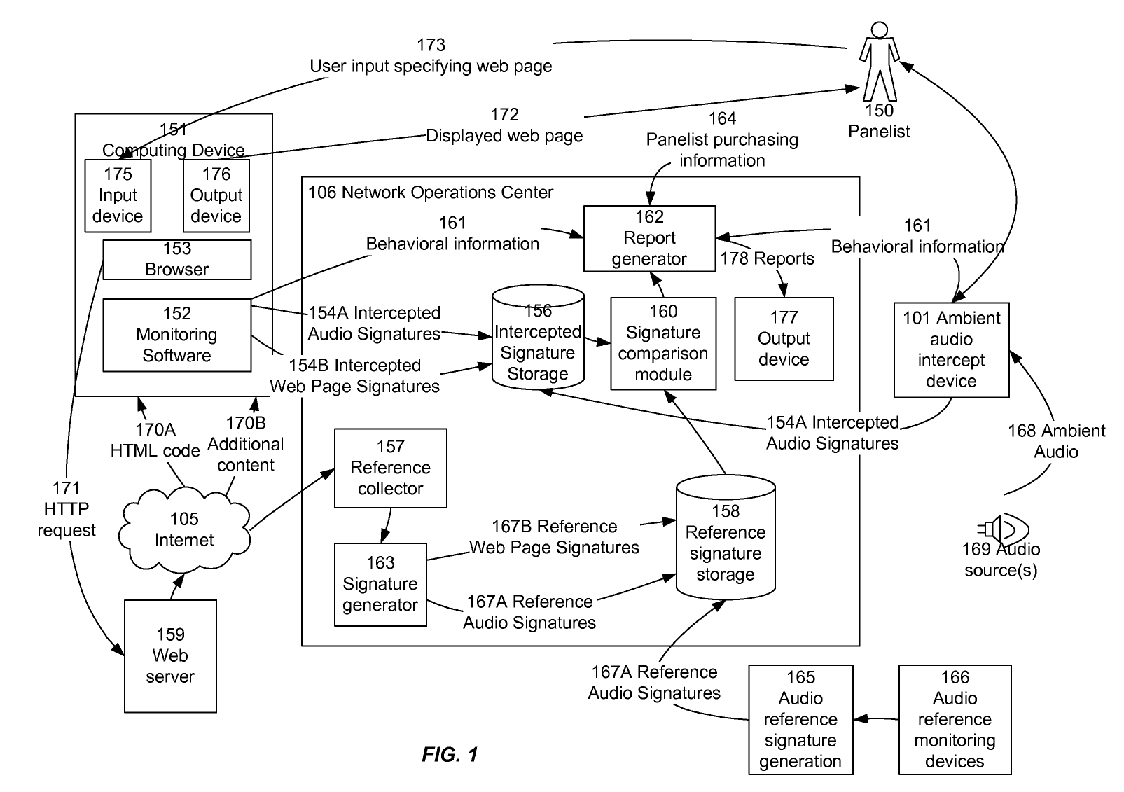

Referring now to FIG. 1, there is shown a block diagram depicting an architecture of the present invention for measuring exposure to media across multiple delivery mechanisms, according to one embodiment. As in FIG. 3, monitoring software 152 on computing device 151 monitors web-based content accessed by panelist 150, and generates intercepted web page signatures 154B for comparison with reference web page signatures 167B. Here, however, monitoring software 152 is also able to intercept a digital audio data stream being output by computing device 151. Thus, monitoring software 152 captures information regarding audio content to which panelist 150 is exposed. In addition to generating web page signatures 154B, monitoring software 152 also generates audio signatures 154A (referred to herein as intercepted audio signatures 154A) that form a representation of audio content to which panelist 150 is exposed. Intercepted audio signatures 154A, along with intercepted web signatures 154B, are sent to network operations center 106 where they are stored in storage device 156.

In addition, in one embodiment, the system of the present invention detects panelist 150 exposure to audio content items via delivery mechanisms other than Internet-based delivery. As described in related U.S. patent application Ser. No. 11/216,543, panelists 150 carry ambient audio intercept devices 101 capable of detecting and recording ambient audio 168 from various audio sources 169. Audio sources 169 can include, for example, television shows, radio programming, movies, video games, and the like. Audio signatures 154A, referred to herein as intercepted audio signatures 154A, are generated from the detected audio. In one embodiment, intercepted audio signatures 154A are generated by ambient audio intercept device 101; in other embodiments, signatures 154A are generated as network operations center 106 based on raw or compressed audio data transmitted by devices 101.

Ambient audio intercept device 101 may be built into a consumer device with some other utility to the user; examples include a mobile phone, PDA, wristwatch, or the like. In alternative embodiments, device 101 can take any other form, such as a standalone device that is carried by or attached to the user. Embedding the functionality of the present invention in a device such as a mobile phone or wristwatch makes it more convenient for a user to carry device, and also encourages the user to keep device 101 in their possession at all times. In one embodiment, device 101 operates passively and requires no user input. In one embodiment, device 101 is equipped with sensors to detect whether it is currently being carried by panelist 150; such sensors can operate, for example, by detecting movement, heat, orientation, or any combination thereof. For example, a determination that device 101 has not moved for some period of time, such as 10 minutes, can indicate that panelist 150 is not actively carrying device 101.

In one embodiment, intercepted audio signatures 154A are generated according to techniques described, for example, in related U.S. patent application Ser. No. 11/216,543. For example, in one embodiment, monitoring software 152 and/or device 101 samples 10 seconds of audio data per 30 seconds received. Such a ratio is particularly effective for detecting exposure to commercials (advertisements), since many such commercials are 30 seconds long. Monitoring software 152 and/or device 101 creates a raw audio file (such as a .WAV file) from the sampled data, and performs a signature transformation to generate a signature file from the raw audio file. In one embodiment, the system of the present invention uses a signature transformation algorithm such as Shazam, described in Wang et al. and available from Shazam Entertainment Ltd., of London, England. This algorithm is also described in Avery Li-chun Wang, “An Industrial-Strength Audio Search Algorithm,” October 2003, and Avery Li-Chun Wang and Julius O. Smith, III, WIPO publication WO0211123A3, 7 Feb. 2002, “Method for Search in an Audio Database.” One skilled in the art will recognize that many other techniques can be used for generating audio signatures 154A. In addition, signature generation can take place at any location or component; for example, in one embodiment, computing device 151 and/or device 101 can transmit raw or compressed audio data to network operations center 106, and signature generation can be performed at network operations center 106.

As discussed above, monitoring software 152 may interface with audio circuitry, such as a sound card or other audio component of computing device 151, to detect audio content being output. By detecting and transforming the audio stream using software 152 running on computing device 151, the system of the present invention is able to detect audio content to which panelist 150 is exposed, even if the audio content is not reliably detectable by device 101. For example, if panelist 150 is using headphones or some other private listening device, software 152 can still detect and transform the audio content, even though audio might not be detectable via an ambient audio recording device. In addition, monitoring of audio via software 152 can produce better results in some situations, where fidelity of the captured audio might otherwise be compromised by background noise, poor speakers or microphone, insufficient volume, or other circumstance that might interfere with audio intercept device's 101 ability to reliably detect exposure to audio content items. In addition, in one embodiment, monitoring software 152 can detect audio content 170C from any other content source, such as a local content source 179; for example, audio content may originate from media such as CDs, DVDs, BluRay discs, local storage, or the like.

In one embodiment, duplication detection is performed so that audio content detected by both monitoring software 152 and by ambient audio intercept device 101 is not counted twice. For example, if panelist 150 is listening to music at a website, using speakers connected to computing device 151, the audio might be detected by monitoring software 152 as well as by device 101. In such a case, the duplicate audio stream is detected so that it is not inadvertently counted twice. In this manner, the viewing is properly attributed to the Internet delivery platform instead of time-delayed television.

In another embodiment, the audio stream being provided to computing device 151 is digitally intercepted in a proxy server (not shown) and provided to network operations center 106. Audio signatures 154A can be generated from the intercepted audio stream at the proxy server or at network operations center 106.

Audio reference monitoring devices 166 are provided, so as to monitor audio media (such as television and radio programming) that is being broadcast or otherwise made available to panelist 150. In general, audio reference monitoring devices 166 are configured so that they monitor particular programming, channels, and/or stations that are of interest. Audio reference signature generation module 165 generates reference audio signatures 167A from the monitored reference audio. In one embodiment, reference audio signatures 167A are generated from the monitored audio according to techniques described, for example, in related U.S. patent application Ser. No. 11/216,543.

In one embodiment, audio reference monitoring devices 166 monitor various media sources for audio content items of interest. Each audio reference monitoring device 166 can be implemented, for example, as a personal computer with a number of tuner cards that can pick up broadcasts. In one embodiment, each device 166 includes four tuner cards, each capable of receiving AM, FM, or television audio signals. An example of the type of tuner card that can be used for implementing the present invention is the ASI8712 or ASI8713 eight-tuner broadcast adapter available from AudioScience, Inc. of New Castle, Del. In one embodiment, several audio reference monitoring devices 166 are provided, running in different locations so as to be able to pick up different markets/stations, and also to provide improved reliability and redundancy. Devices 166 can be configured, for example, to simultaneously receive 32 channels in parallel, taking audio components only, and to convert the received audio into digital form via sampling. In one embodiment, devices 166 are located in a location that is remote with respect to networks operations center 106 (for example, in a location suitable for receiving media items of potential interest); after signatures have been generated by signature generation module 165, signals containing reference signatures 167A are transmitted to network operations center 106 via the Internet or by other means. In another embodiment, devices 166 are located at network operations center 106. In another embodiment, devices 166 transmit raw or compressed audio files to network operations center 106, and reference signatures 167A are generated at network operations center 106.

In one embodiment, reference collector 157 can also collect audio media via the Internet 105. For example, reference audio can be provided to network operations center 106 via the Internet 105, for comparison with ambient audio 168 and/or audio to which panelist 150 is exposed either via the Internet 105. In such an embodiment, signature collector 163 generates reference audio signatures 167A.

Reference audio signatures 167A are stored in reference signature storage 158. These reference audio signatures 167A representing audio can be stored in the same storage device as that used to store reference web page signatures 167B representing web-based content; alternatively, reference audio signatures 167A can be stored in a different storage device than that used to store reference web page signatures 167B. Accordingly, reference signature storage 158 can include any or all of the following, in one or a plurality of storage devices:
Reference audio signatures 167A representing reference audio monitored by devices 166;
Reference audio signatures 167A representing reference audio collected via the Internet 105;
Reference web page signatures 167B representing web-based content; and/or
Reference audio signatures 167A and/or web page signatures 167B provided directly to network operations center 106.

As described above in connection with FIG. 3, signature comparison module 160 compares intercepted web page signatures 154B for a panelist's 150 Internet browsing activity with reference web page signatures 167B. In one embodiment, signature comparison module 160 also compares intercepted audio signatures 154A (collected via monitoring software 152 and/or via ambient audio intercept device 101) with reference audio signatures 167A. In one embodiment, both types of comparisons are performed by the same component of network operations center 106; in another embodiment, different components are provided for the web page signature comparison and the audio signature comparison, respectively.

In one embodiment, comparison of audio signatures is performed according to techniques described, for example, in related U.S. patent application Ser. No. 11/216,543. In one embodiment, signature comparison module 160 uses a correlation algorithm as described in Avery Li-chun Wang, “An Industrial-Strength Audio Search Algorithm,” October 2003, and Avery Li-Chun Wang and Julius O. Smith, III, WIPO publication WO0211123A3, 7 Feb. 2002, “Method for Search in an Audio Database.”

Signature comparison performed by module 160 can include any or all of the following, in any combination:
Comparison of intercepted web page signatures 154B with reference web page signatures 167B obtained via web crawl or other traversal of the web;
Comparison of intercepted web page signatures 154B with reference web page signatures 167B directly provided to network operations center 106;
Comparison of intercepted audio page signatures 154A from monitoring software 152 with reference audio signatures 167A representing audio collected via the Internet 105 by reference collector 157;
Comparison of intercepted audio page signatures 154A from monitoring software 152 with reference audio signatures 167A representing audio collected via audio reference monitoring devices 166;
Comparison of intercepted audio page signatures 154A from ambient audio intercept device 101 with reference audio signatures 167A representing audio collected via the Internet 105 by reference collector 157;
Comparison of intercepted audio page signatures 154A from ambient audio intercept device 101 with reference audio signatures 167A representing audio collected via audio reference monitoring devices 166; and/or
Comparison of intercepted audio page signatures 154A with reference audio signatures 167A directly provided to network operations center 106.

In one embodiment, all signature comparison is performed by a single component. In another embodiment, distinct components are provided at network operations center 106 for performing different types of signature comparison.

In one embodiment, report generator 162 generates reports 178 based on audio signature comparison and web page signature comparison. Reports can be presented on any output device 177, such as a screen or printer, and/or can be stored or transmitted. Reports 178 can take any form as specified by a website operator, advertiser, or other stakeholder. For example, reports 178 can include advertising conversion reports indicating the degree to which panelists 150 exposed to advertisements tend to visit advertised web pages and/or purchase advertised products and services. Reports 178 can also show the relationship between panelist's 150 website visitation patterns and audio to which panelist 150 has been exposed.

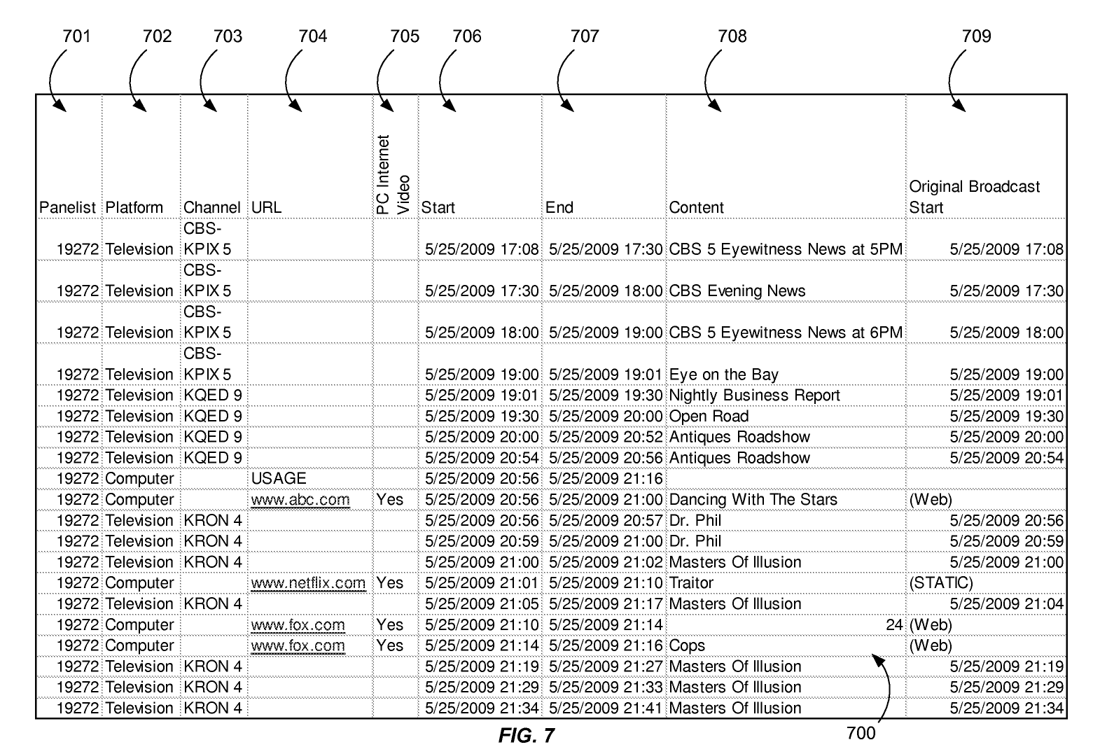

Referring now to FIG. 7, there is shown an example of a report 700 showing relationships between panelist's 150 website visitation patterns and audio to which panelist 150 has been exposed, generated according to one embodiment of the present invention. Column 701 identifies a panelist 150 by panelist ID number. Column 702 specifies the platform by which the media was delivered, such as by computer or by television. Column 703 specifies the channel, if applicable (such as for television content). Column 704 specifies the URL, if applicable (such as for Internet content). Column 705 indicates whether or not the content included video delivered via personal computer and/or Internet. Columns 706 and 707 indicate the start and end dates/times, respectively, for the delivered content. Column 708 includes a description of the content. Column 709 indicates the original broadcast date/time of the content, if applicable, for example to indicate content that may have been recorded on a DVR for later playback. In column 709, content delivered via computer can be indicated as “Web” if web-based, or “Static” if static content delivered for viewing to the user (such as a downloaded movie).

In one embodiment, ambient audio intercept device 101 transmits behavioral information 161 to network operations center 106. Such behavioral information can include, for example, panelist 150 location (determined, for example, by GPS location detection), use of device 101 to make telephone calls or engage in other communications, and the like. In one embodiment, device 101 is equipped with sensors to detect whether it is currently being carried by panelist 150; such sensors can operate, for example, by detecting movement, heat, orientation, or any combination thereof. For example, a determination that device 101 has not moved for some period of time, such as 10 minutes, can indicate that panelist 150 is not actively carrying device 101. In one embodiment, behavioral information 161 is used by report generator 162 to generate reports 178 that correlate specific behaviors (such as location) with media exposure data. Thus, for example, ambient audio 168 that is detected while device 101 was not being carried by panelist 150 can be ignored or assigned lesser weight in reports 178.

Referring now to FIG. 2, there is shown a flow diagram depicting a method of measuring exposure to media across multiple delivery mechanisms according to one embodiment. In one embodiment, the steps depicted in FIG. 2 are performed by a system such as that described above in connection with FIG. 1. Accordingly, reference numerals referring to components of FIG. 1 are included in the following description; however, one skilled in the art will recognize that the method of FIG. 2 can be performed by systems having different components and architecture than those shown in FIG. 1.

Audio reference signature generation module 165 generates 201 reference signatures 167A for audio content items received by audio reference monitoring devices 166. In one embodiment, step 201 also includes generation, by signature generator 163, of reference signatures 167A for audio content items collected by reference collector 157. Signature generator 163 also generates 202 reference signatures 167B for HTML content items and other web-based content collected by reference collector 157. As described above, these content items can include web-based content collected during a web crawl (ether comprehensive or constrained), and/or content items provided directly to signature generator 163. Reference signatures 167 are stored 203 in reference signature storage 158.

Monitoring software 152 monitors 204 website visitation of panelist 150, based on web pages and other web content viewed via browser 153, and generates 205 intercepted web page signatures 154B. Monitoring software 152 also generates 206 intercepted audio signatures 154A for monitored web-based audio content.

Ambient audio intercept device 101 monitors 207 ambient audio 168 from any number of audio source(s) 169, and generates 208 intercepted audio signatures 154A.

Intercepted signatures 154A, 154B are transmitted to network operations center 106, where they are stored 209 in intercepted signature storage 156.

One skilled in the art will recognize that the above-described steps can be performed sequentially or in parallel. For example, website visitation monitoring 204 can take place while reference signatures 167A, 167B are still being generated 201, 202 and/or stored 203.

Signature comparison module 160 compares 210 intercepted signatures 154A, 154B with reference signatures 167A, 167B. Based on the comparison, in one embodiment report generator 162 generates 211 and outputs reports 178 on output device 177. In other embodiments, based on the comparison, certain content items are identified for presentation to the user. In yet other embodiments, based on the comparison, certain content items are identified for presentation to other users having similar demographic characteristics, and/or other relevant characteristics, as the user.

By enabling generation of reports 178 that combine website visitation information (derived from monitored browsing behavior) with panelist 150 exposure to audio content, the system and method of the present invention are able to provide insight into patterns of media exposure across multiple delivery mechanisms. In some embodiments, by using such information to select content items for presentation to a user, the system and method of the present invention are able to identify content items, including for example advertisements, that are more likely to be of interest to the user.

The system and method of the present invention can be used for monitoring audiovisual content, by monitoring the audio component of the audiovisual content items. In addition, signatures can be generated from audiovisual content by hashing or by some other mechanism. Accordingly, the system and method of the present invention do not require changes to content, and facilitate measurement of exposure to content across multiple delivery mechanisms, including Internet-delivered video content. No cooperation of content owners is required.

The audio monitoring techniques of the present invention can be used to measure the duration of content viewing/listening. In addition, the system of the present invention can measure exposure to audio content even when the sound is diverted to headphones because monitoring software 152 is able to intercept audio within computing device 151, even when no ambient audio is present. Furthermore, the techniques of the present invention provide a mechanism for measuring exposure to web-based content regardless of the source URL of the web-based content; exposure is thereby measured accurately even when the same content is available from multiple URLs.

The invention can also be used outside of the media research field. References herein to a “panelist” should be considered to refer to any individual such as a user, viewer, listener, website visitor, or the like. One application of the ability to profile each user's multi-platform media consumption is the delivery of advertisements (or other content, products, offers, and the like) to each user based on his or her individual media consumption profile and/or based on their exposure to specific content consumed on any of the monitored devices.

In various embodiments, the present invention can be implemented as a system or a method for performing the above-described techniques, either singly or in any combination. In another embodiment, the present invention can be implemented as a computer program product comprising a computer-readable storage medium and computer program code, encoded on the medium, for causing a processor in a computing device or other electronic device to perform the above-described techniques.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared, transformed, and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers and/or other electronic devices referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

Accordingly, in various embodiments, the present invention can be implemented as software, hardware, or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or nonportable. Examples of electronic devices that may be used for implementing the invention include: a mobile phone, personal digital assistant, smartphone, kiosk, desktop computer, laptop computer, consumer electronic device, television, set-top box, or the like. An electronic device for implementing the present invention may use an operating system such as, for example, Microsoft Windows Vista available from Microsoft Corporation of Redmond, Wash., or any other operating system that is adapted for use on the device.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

While the invention has been particularly shown and described with reference to a preferred embodiment and several alternate embodiments, it will be understood by persons skilled in the relevant art that various changes in form and details can be made therein without departing from the spirit and scope of the invention.

What is claimed is:

1. A computer-implemented method for measuring user exposure to web content, comprising:
transforming a plurality of web content items to obtain a plurality of reference signatures;
in an electronic storage device, storing the obtained reference signatures;
monitoring user exposure to web content items;
transforming the web content items to generate a plurality of intercepted signatures;
comparing the plurality of intercepted signatures with at least a subset of the stored reference signatures;
responsive to the comparison, identifying user exposure to at least one web content item;
based on the identified user exposure, selecting at least one content item for presentation to a user from a plurality of candidate content items; and
presenting the selected at least one content item to the user.

2. A computer-implemented method for measuring user exposure to audio content, comprising:
transforming a plurality of reference content items to obtain a plurality of reference signatures, each reference content item comprising audio;
in an electronic storage device, storing the obtained reference signatures;
at a computing device, monitoring user exposure to content items comprising audio, by monitoring at least one electrical signal associated with an audio output component of the computing device;
transforming the content items to generate a plurality of intercepted signatures;
comparing the plurality of intercepted signatures with at least a subset of the stored reference signatures;
responsive to the comparison, identifying user exposure to at least one content item comprising audio;
generating at least one report indicating the identified user exposure to at least one content item comprising audio; and
at an output device, outputting the generated report.

3. The method of claim 2, wherein the content comprising audio comprises audiovisual content.

4. The method of claim 2, wherein monitoring user exposure to content items comprising audio comprises monitoring user exposure to content items originating from at least one selected from the group consisting of:
an optical storage device;
a magnetic storage device;
a network-based source;
a server; and
a broadcast source.

5. A computer-implemented method for measuring user exposure to audio content, comprising:
transforming a plurality of reference content items to obtain a plurality of reference signatures, each reference content item comprising audio;
in an electronic storage device, storing the obtained reference signatures;
at a computing device, monitoring user exposure to content items comprising audio, by monitoring at least one electrical signal associated with an audio output component of the computing device;
transforming the content items to generate a plurality of intercepted signatures;
comparing the plurality of intercepted signatures with at least a subset of the stored reference signatures;
responsive to the comparison, identifying user exposure to at least one content item comprising audio;
based on the identified user exposure, selecting at least one content item for presentation to a user from a plurality of candidate content items; and
presenting the selected at least one content item to the user.

6. A computer program product for measuring user exposure to web content, comprising:
a computer-readable storage medium; and
computer program code, encoded on the medium, for causing a processor to perform the steps of:
transforming a plurality of web content items to obtain a plurality of reference signatures;
in an electronic storage device, storing the obtained reference signatures;
monitoring user exposure to web content items;
transforming the web content items to generate a plurality of intercepted signatures;
comparing the plurality of intercepted signatures with at least a subset of the stored reference signatures;
responsive to the comparison, identifying user exposure to at least one web content item;
based on the identified user exposure, selecting at least one content item for presentation to a user from a plurality of candidate content items; and
presenting the selected at least one content item to the user.

7. A computer program product for measuring user exposure to audio content, comprising:
a computer-readable storage medium; and
computer program code, encoded on the medium, for causing a processor to perform the steps of:
transforming a plurality of reference content items to obtain a plurality of reference signatures, each reference content item comprising audio;
in an electronic storage device, storing the obtained reference signatures;
at a computing device, monitoring user exposure to content items comprising audio, by monitoring at least one electrical signal associated with an audio output component of the computing device;
transforming the content items to generate a plurality of intercepted signatures;
comparing the plurality of intercepted signatures with at least a subset of the stored reference signatures;
responsive to the comparison, identifying user exposure to at least one content item comprising audio;
generating at least one report indicating the identified user exposure to at least one content item comprising audio; and
at an output device, outputting the generated report.

8. The computer program product of claim 7, wherein the content comprising audio comprises audiovisual content.

9. The computer program product of claim 7, wherein the computer program code for causing a processor to perform the step of monitoring user exposure to content items comprising audio comprises the computer program code for causing a processor to perform the step of monitoring user exposure to content items originating from at least one selected from the group consisting of:
an optical storage device;
a magnetic storage device;
a network-based source;
a server; and
a broadcast source.

10. A computer program product for measuring user exposure to audio content, comprising:
a computer-readable storage medium; and
computer program code, encoded on the medium, for causing a processor to perform the steps of:
transforming a plurality of reference content items to obtain a plurality of reference signatures, each reference content item comprising audio;
in an electronic storage device, storing the obtained reference signatures;
at a computing device, monitoring user exposure to content items comprising audio, by monitoring at least one electrical signal associated with an audio output component of the computing device;
transforming the content items to generate a plurality of intercepted signatures;
comparing the plurality of intercepted signatures with at least a subset of the stored reference signatures;
responsive to the comparison, identifying user exposure to at least one content item comprising audio;
based on the identified user exposure, selecting at least one content item for presentation to a user from a plurality of candidate content items; and
presenting the selected at least one content item to the user.

11. A system for measuring user exposure to web content, comprising:
a reference signature generator, for transforming a plurality of web content items to obtain a plurality of reference signatures;
an electronic storage device, for storing the obtained reference signatures;
a user exposure monitoring device, for monitoring user exposure to web content items and for transforming the web content items to generate a plurality of intercepted signatures;
a signature comparison module, for:
comparing the plurality of intercepted signatures with at least a subset of the stored reference signatures; and
responsive to the comparison, identifying user exposure to at least one web content item;
a content item selector, for selecting at least one content item for presentation to a user from a plurality of candidate content items, based on the identified user exposure; and
an output device, for presenting the selected at least one content item to the user.

12. A system for measuring user exposure to audio content, comprising:
a reference signature generator, for transforming a plurality of reference content items to obtain a plurality of reference signatures, each reference content item comprising audio;
an electronic storage device, for storing the obtained reference signatures;
a user exposure monitoring device, for monitoring user exposure to content items comprising audio, by monitoring at least one electrical signal associated with an audio output component of the computing device, and for transforming the content items to generate a plurality of intercepted signatures;
a signature comparison module, for:
comparing the plurality of intercepted signatures with at least a subset of the stored reference signatures;
responsive to the comparison, identifying user exposure to at least one content item comprising audio;
a report generator, for generating at least one report indicating the identified user exposure to at least one content item comprising audio; and
an output device, for outputting the generated report.

13. The system of claim 12, wherein the content comprising audio comprises audiovisual content.

14. The system of claim 12, wherein the user exposure monitoring device monitors user exposure to content items comprising audio by monitoring user exposure to content items originating from at least one selected from the group consisting of:
an optical storage device;
a magnetic storage device;
a network-based source;
a server; and
a broadcast source.

15. A system for measuring user exposure to audio content, comprising:
a reference signature generator, for transforming a plurality of reference content items to obtain a plurality of reference signatures, each reference content item comprising audio;
an electronic storage device, for storing the obtained reference signatures;
a user exposure monitoring device, for monitoring user exposure to content items comprising audio, by monitoring at least one electrical signal associated with an audio output component of the computing device, and for transforming the content items to generate a plurality of intercepted signatures;
a signature comparison module, for:
comparing the plurality of intercepted signatures with at least a subset of the stored reference signatures;
responsive to the comparison, identifying user exposure to at least one content item comprising audio;
a content item selector, for selecting at least one content item for presentation to a user from a plurality of candidate content items, based on the identified user exposure; and
an output device, for presenting the selected at least one content item to the user.
